(19) United States
(12) Patent Application Publication
(10) Pub. No.: US 2016/0166113 A1
(43) Pub. Date: Jun. 16, 2016

(54) SALAD DRYER

(71) Applicant: ALAN LYONS, Plymouth, MA (US)

(72) Inventor: ALAN LYONS, Plymouth, MA (US)

(21) Appl. No.: 14/569,758

(22) Filed: Dec. 14, 2014

(51) Int. Cl. A47J 43/04

(52) U.S. Cl. CPC A47J 43/04

(57) ABSTRACT

The THE SALAD DRYER uses a de-watering process which provides very dry and crisp salad greens in an automated appliance. The general process used in THE SALAD DRYER is evaporation due to wind/air being forced through a salad tumbling perforated drum.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF INVENTION

To provide a fine tasty salad, the greens must be dry! Salad dressings will not cling as well to wet greens. This usually means the salad will taste bland and may be soggy as a result of the wetness of the ingredients.

There are several salad dryers that rely on removing the water/moisture using centrifugal force by spinning them in a perforated drum, but they do not remove all the moisture. The ingredients are forced outward in the drum and moisture is trapped between the leaves since they are in a layered form and are pressed together by the centrifugal force.

Other methods are time consuming as they are done manually by using cloths or paper towel to dry the leaves.

### BRIEF SUMMARY OF INVENTION

The THE SALAD DRYER uses a different approach which provides very dry and crisp salad greens in an automated appliance. The process used in THE SALAD DRYER is evaporation due to wind/air velocity. Before automatic clothes dryers the washing/laundry would be hung on the clothes line to dry, on a nice windy day they would dry quickly due to evaporation as the wind blew through them, even more quickly if there was Sun to warm the moisture. This process can also be seen when after a rain shower if there is a wind everything dries more quickly. Water molecules are held together by their own force but can be forced apart by the wind

In the process used in THE SALAD DRYER, the wind is provided by a fan and the salad greens are tumbled at a slow speed to ensure the air reaches both sides of the leaves. Due to the high velocity of the air passing across the greens the moisture will be given off as a vapor.

The design is such that the vegetables will not be damaged or bruised during the drying process.

The units and process described will apply to a range of sizes:

The Petit Unit will be for 2-4 salads;

The Commercial Unit for use in restaurants/catering etc.;

The Standard Unit described will process 6 salads and is the basis for all the other sizes. This Unit is detailed in the attached drawings.

### BRIEF DESCRIPTION OF THE SEVERAL VIEWS OF THE DRAWINGS

Page 1: Front View.

Page 2: End View

Page 3: End View.

Page 4: Top View

Page 5. Rear View

Page 6 Hole pattern for inlet air to Fan.

Page 7 Partial view of Control Unit Basket Drive System

Page 8 Front View, Unit with Basket and Base with sloping sides.

Page 1: A front view of the Salad Dryer assembly and the BASE which holds and operates the Basket that contains the salad.

Page 2: On the Left Side is the Latch/Bearing assembly. The Latch, slides along the axis of the basket retainers/plate, locks the Basket in place as it rotates and when it is in position to be unloaded

Page 3: On the Right Side is the same basket holder/latch assembly but also holds the DC Motor and gear mechanism that rotates the basket (see Page 7). If the latches are not properly in place the rotation will not start. Also, part of the Control Unit assembly Page 7 is a PCB that will control the humidity sensor that monitors the air as it exits the Basket and will have automatic shut the off when the contents are dry. It also aligns the Baskets so the Latches are in proper position for removal of baskets. The push button switch will start the cycle.

Page 4: There are four vanes in the base which are set at an angles to guide the air from the fan for even distribution across the width of the basket.

Page 5: On the rear of the assembly shown is the input connector, this supplies the 12 v dc for the system from the ac/dc wall connector.

The preferred material for base will be a rigid injection molded plastic. There will be 4 feet integral to the unit, the rear feet will have a soft pad added to prevent housing from moving/sliding during the drying cycle.

The Basket Assembly

The Basket Assembly is made up of 2 identical halves that are held together during the drying cycle by the latch assemblies at each end of the Base.

There is a small plate molded into each end of the Basket that locates in the latch housing. The basket has a hole pattern to maximize the percentage of open area. Along the top inside of each basket is a deep rib that holds the leaves while the basket rotates and promotes the tumbling action of the lettuce etc.

The preferred material for the basket is a clear injection molded plastic, this allows for generous inside radii preventing damage to the contents and aiding the cleaning process.

An option is to have Baskets and the Base with sloping sides as shown on Page 8.

### DETAILED DESCRIPTION OF THE INVENTION

### Process for Using Invention

The leaves to be dried are placed in one half of the Basket and washed under the faucet in the sink. The excess water can be removed by gently tossing them around The basket can be filled to the rim with lettuce etc., it is then placed in the base, the top half of the basket placed on top of the bottom half and the latches slide into place. Press the switch on the front of the base and the drying process will begin and shut off when the leaves are dry.

The drying action work as follows: the drum will rotate slowly in the direction shown into the airflow from the fan. Also, due to the volume of air guided by the internal vanes, under pressure from the fan, the area under the Basket will be pressurized, moving the air through the holes in the basket. Air from the top half of the fan enters the top half of the Basket Assembly helping air reach both sides of the leaves. The gap between the basket and base is kept to a minimum to reduce air from leaking out rather than through the basket.

Rotating the basket at low speed reduces the sheer effect on the air passing through the holes into the basket and aids the tumbling effect of the ribs in the basket.

As the leaves are tumbled, air from the top half of the fan blows into the top half of the Basket, reaching both sides of the leaves during the tumbling/rotating process.

As mentioned earlier the water is removed through evaporation, because the moisture is on the surface of the leaves and the air is moving at relatively high velocity. Most of the vapor will escape when the basket is outside of the base, experiments on prototypes show very small amounts of moisture in the base when the drying process is complete.

It is possible to speed up the evaporation process by heating the air, the leaves will not be warmed due to the effect of evaporative cooling. The heater would be shut down part way through the process as the evaporation rate slows due to reduction in moisture.

When the drying process is complete and the Basket has stopped rotating the Basket assembly is moved automatically into position so the latches can slide outwards and the Baskets can be removed.

There is also a cut-out at each end of the Base so the lower half of the Basket containing the leaves can easily be removed.

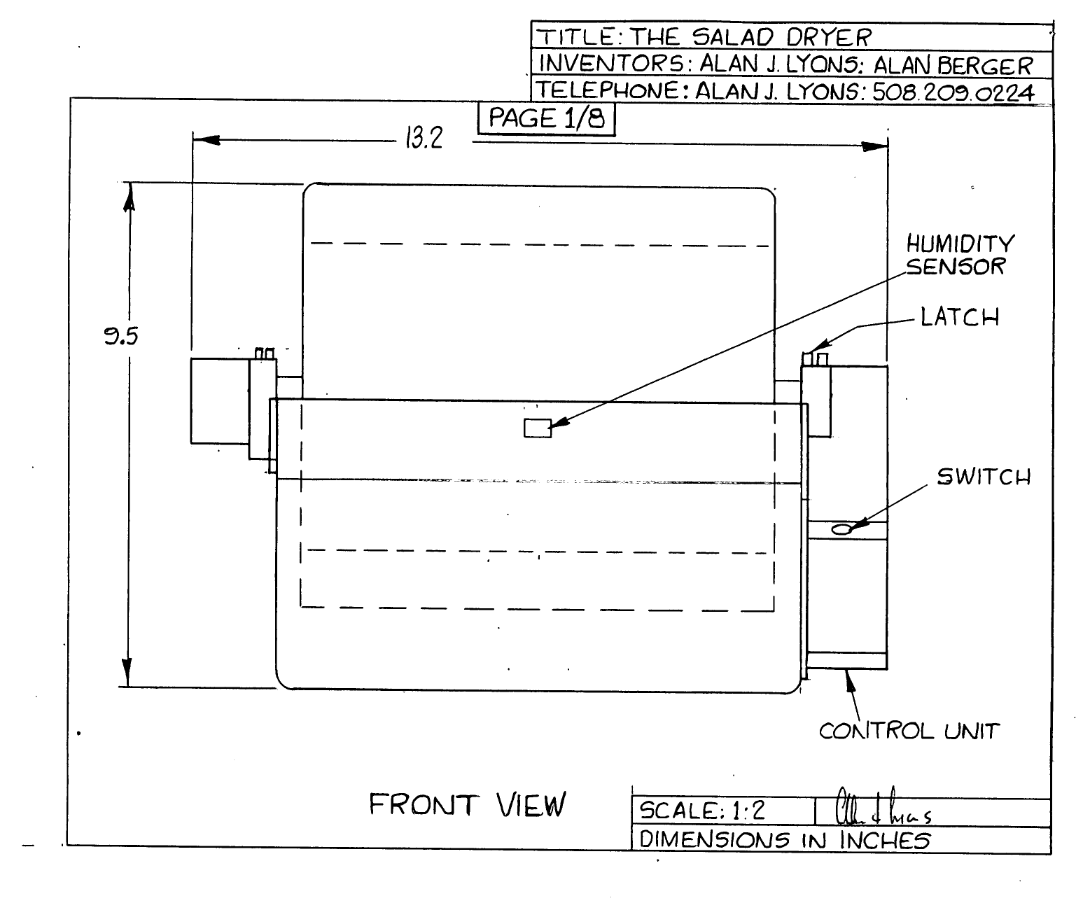

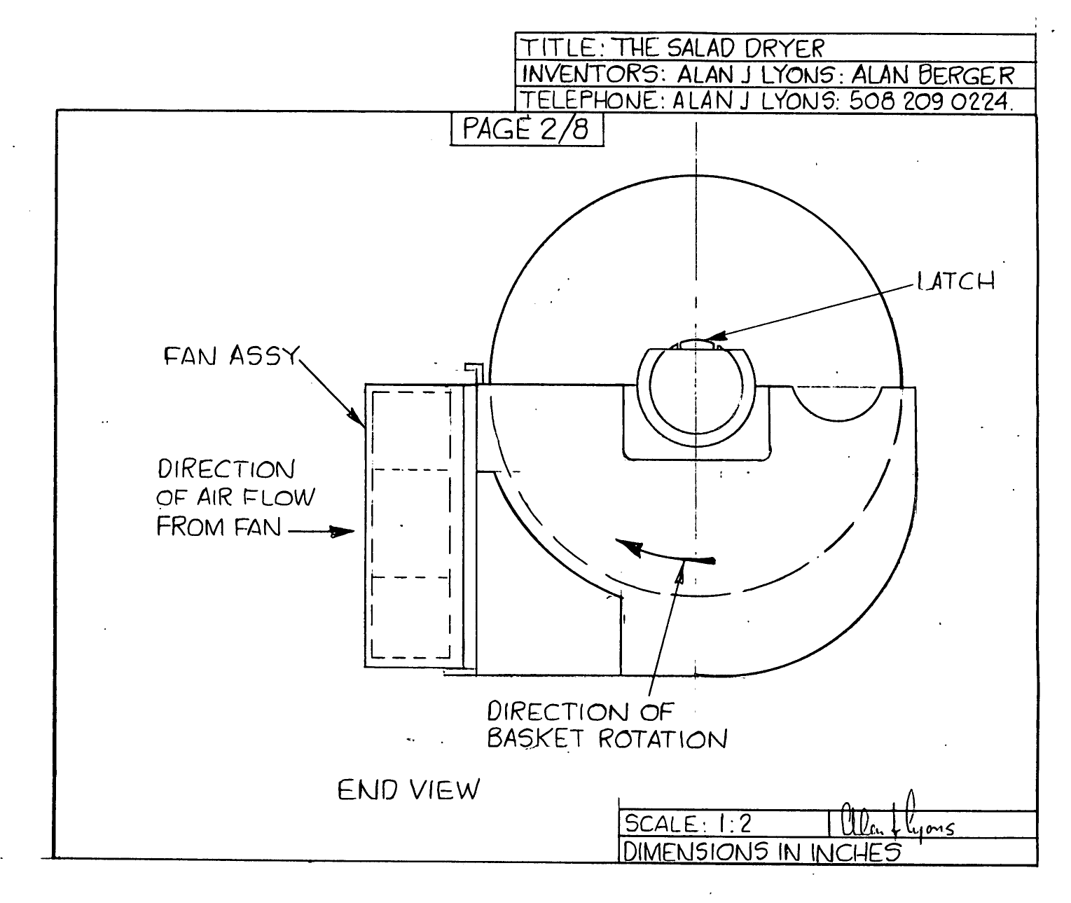

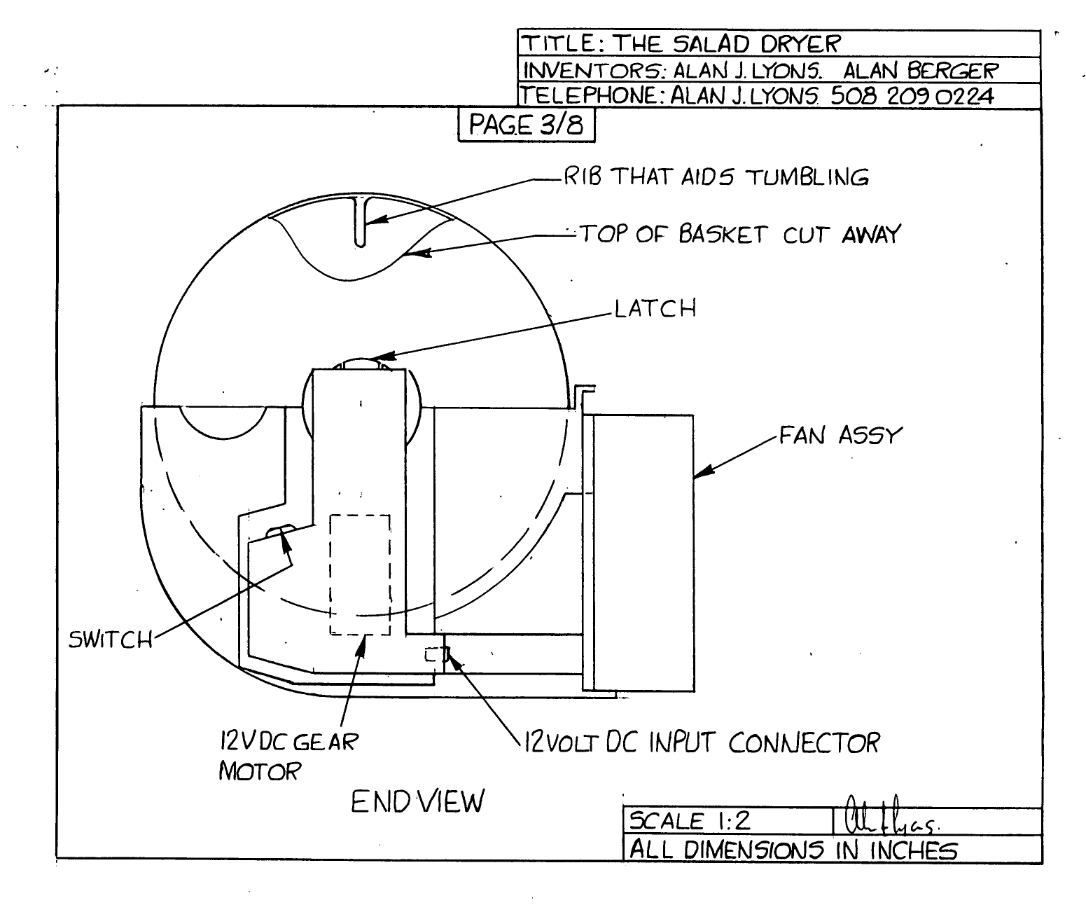

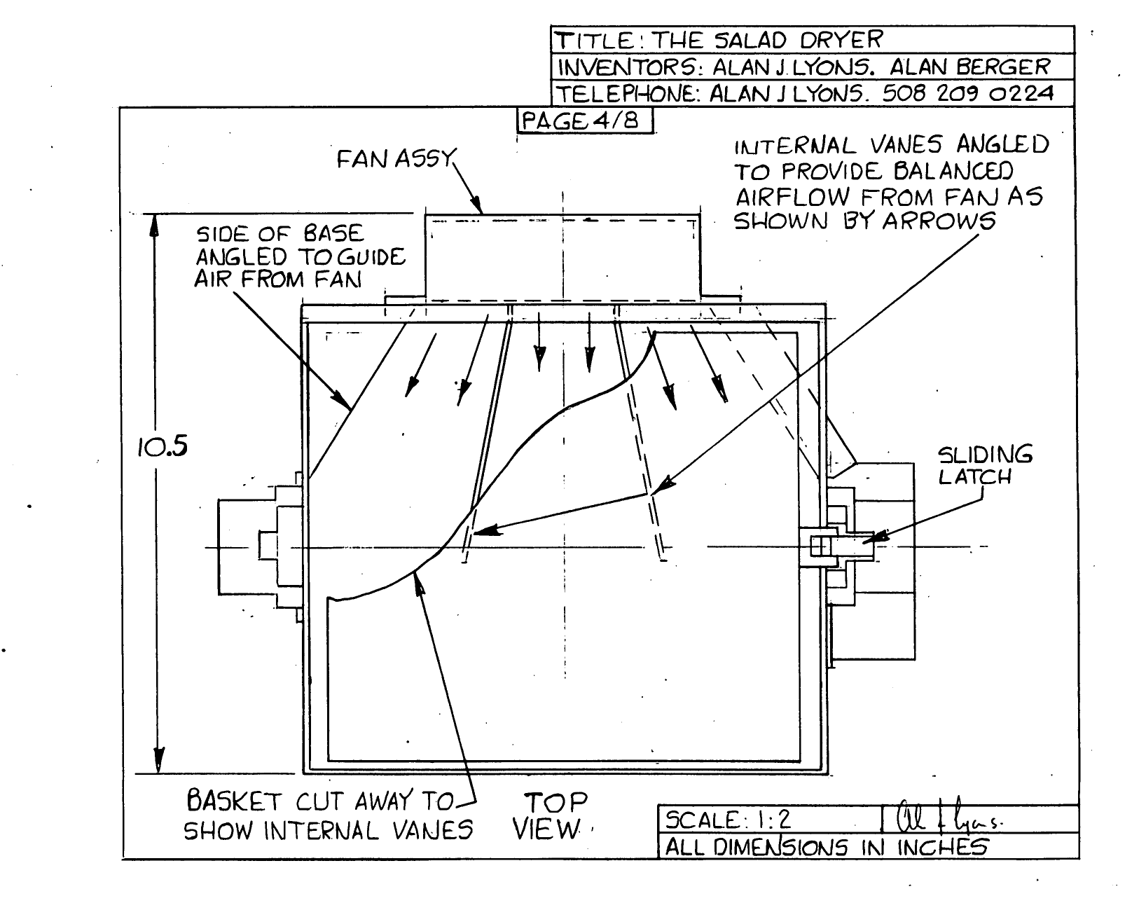

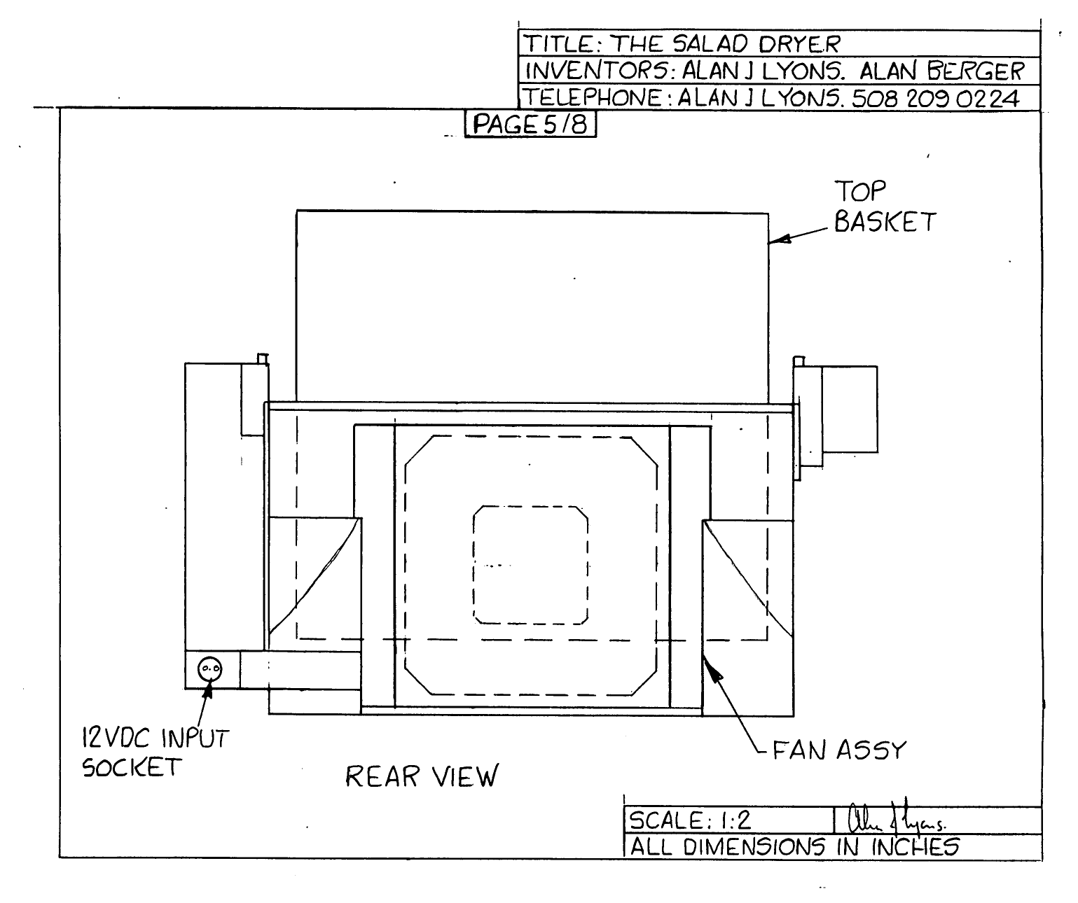

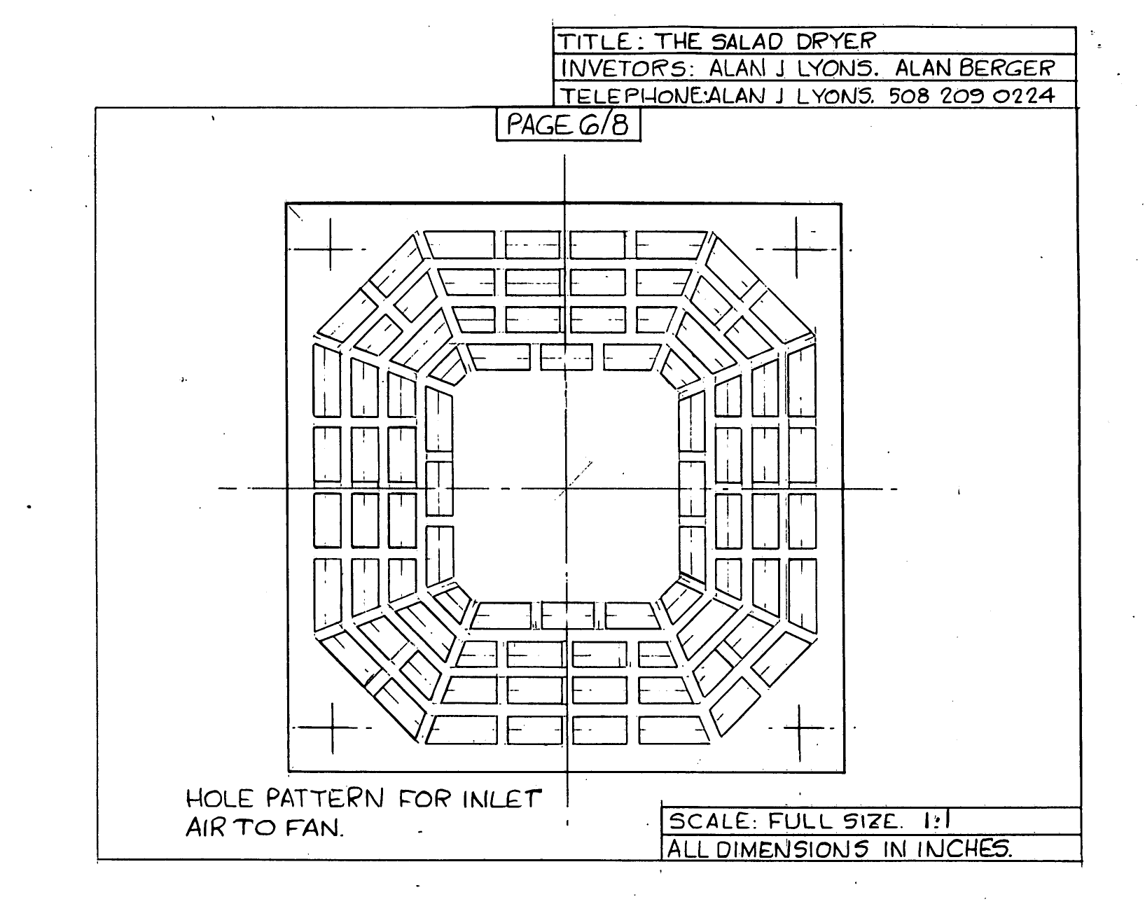

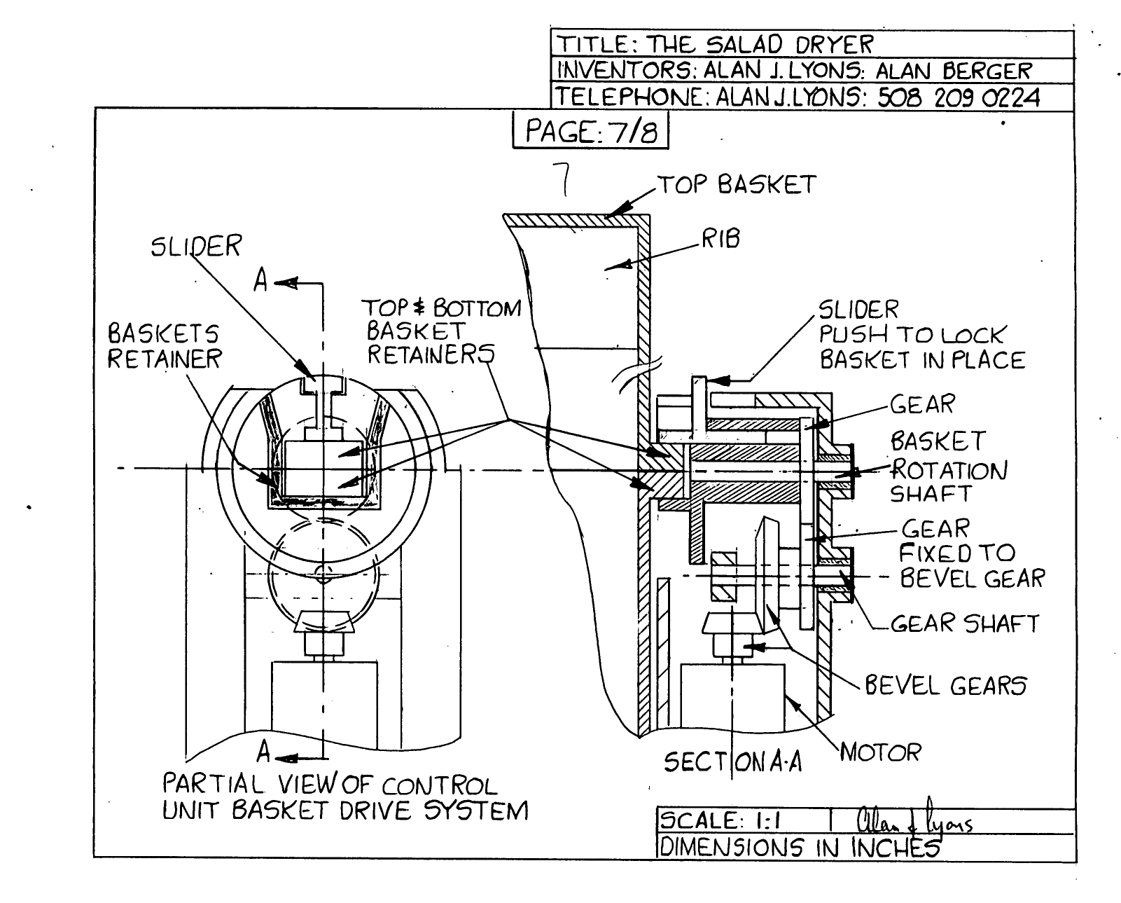

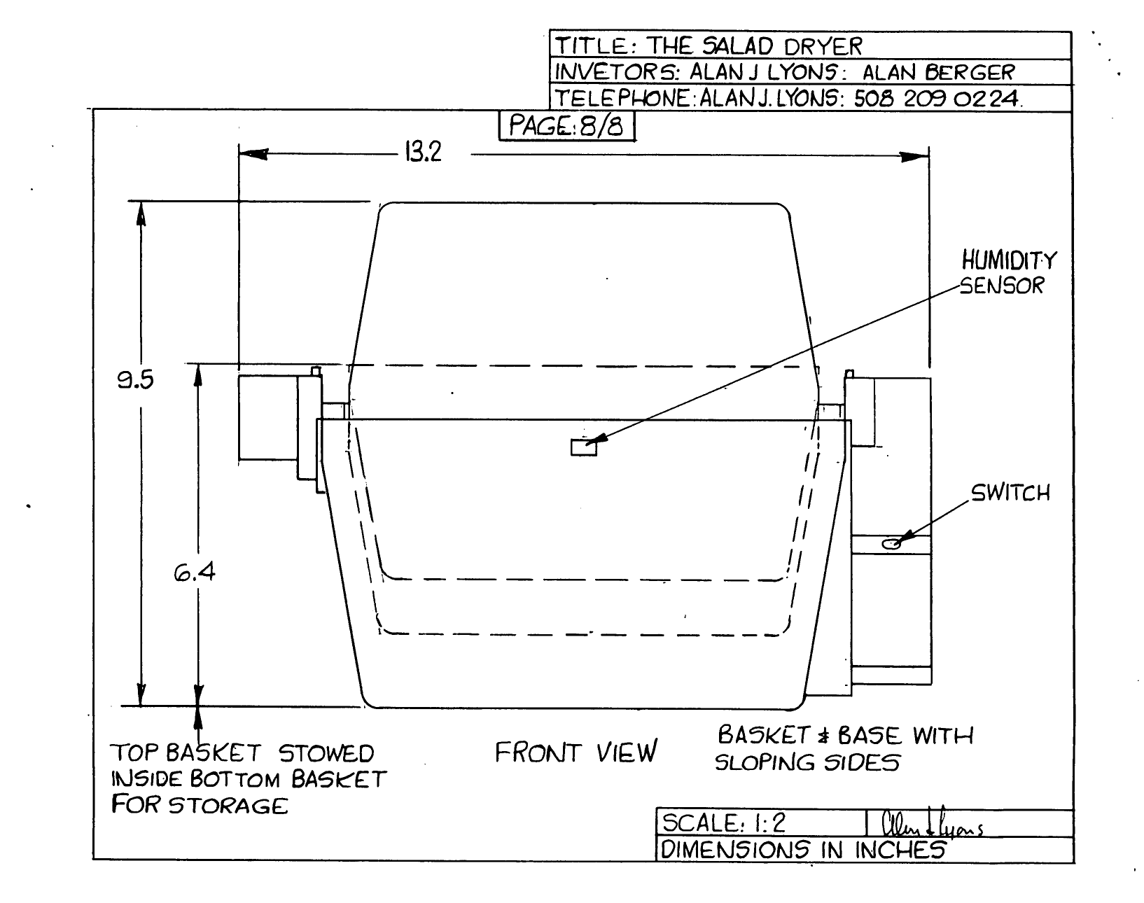

Storing the unit: When the unit has been cleaned the unit can be stored as shown in FIG. 8 with one basket fitting inside the other.

1. I claim that a patent be granted to me for the right to produce solely an electrically powered salad dryer of all sizes, using a tumbler drum with an electrically powered fan that forces air through the tumbler and its salad contents in order to dry the salad.
